(19) United States
(12) Patent Application Publication
(10) Pub. No.: US 2003/0120558 A1
(43) Pub. Date: Jun. 26, 2003

(54) Collection system with lay-open on web

(76) Inventors: Toshio Yagihashi, Kanagawa (JP); Tooru Kawada, Kanagawa (JP); Syunsuke Oda, Hong Kong (CN)

Correspondence Address: STRAUB & POKOTYLO, 1 BETHANY ROAD, SUITE 83, BUILDING 6, HAZLET, NJ, 07730, US

(21) Appl. No.: 10/317,479

(22) Filed: Dec. 12, 2002

(30) Foreign Application Priority Data
Dec. 26, 2001 (JP) 394261/2001

(51) Int. Cl. G06F 17/60

(52) U.S. Cl. 705/26

(57) ABSTRACT

Supply department side determines and lays open data to be laid open among collection parts based on lay-open level corresponding to the confidential level of the collection parts, while specifying suppliers qualified to read the lay-open data. The lay-open ranking is determined by hierarchically ranking the collection department side into a plurality of layers, determining the rating for judging the confidential level of the collection parts and by taking the individual ratings determined for the plurality of hierarchical layers into considerations. Also, on the collection department side, registered suppliers are classified into a plurality of supplier rank groups, and lay-open data are laid open only to suppliers belonging to a rank group corresponding to a pertinent confidential level.

### BACKGROUND OF THE INVENTION

This application claims benefit of Japanese Patent Application No. 2001-394261 filed on Dec. 26, 2001, the contents of which are incorporated by the reference.

The present invention relates to collection systems with lay-open on web for presenting collection data about subject to be collected such as parts, articles, services, etc. on web to suppliers, accepting supplier's applications for collection and determining suppliers for collecting collection parts based on the application data, while managing the supplier data.

A parts collection system with lay-open on web is used for collecting electronic parts, mechanical parts and other parts used for the manufacture of such completed products as electric apparatuses and vehicles. In this parts collection system, a manager (i.e., collection side) of the system lays open collection parts data for describing detailed contents of parts, on a web for suppliers so that anybody can read the data. Suppliers having read the data can apply for the parts collection by transmitting a parts collection application in a predetermined format to the manager. A parts supplier is determined based on the application contents. When a plurality of suppliers have applied, a supplier is provisionally determined after price competition and so forth.

For final determination of the provisional supplier as the actual supplier, an intermediary in-charge person determines final parts specifications, parts prices, terms, etc. after making special preliminary arrangements about data which can not be generally laid open. To this end, independent adjustments are made by holding meetings or by means of telephone or facsimile communication or electronic mails.

In the above prior art parts collection system based on lay-open on web, collection parts data are simultaneously laid open all over the world in a web lay-open system. However, since collection parts data are issued to the indefinite multitude, special data (such as highly confidential data) on the manager side which can not be generally laid open, are not laid open, but are laid open at the time of individual detailed preliminary arrangements after the provisional or actual determination of the supplier. Therefore, it is difficult to quickly determine the supplier, which is undesired from the standpoint of the process efficiency.

In the case of collection of parts concerning products, which are under development or scheduled to be developed in the future, data of the parts can not be laid open for anybody if the parts contains important and highly confidential data including know-how of the product. On the other hand, if sufficient data are not laid open, the supplier side may not be above to make application due to lack of application requirements, and also the collection side may encounter troubles in the fostering of promising suppliers.

Furthermore, since the collection parts data are issued to the indefinite multitude, an unexpectedly large number of suppliers may sometimes apply for a parts collection. In such case, it is difficult to individually and quickly grasp and recognize the quality (such as trust, technical power and scale) of the suppliers as such large number of appliers, and it is impossible to make efficient fostering and management of new suppliers.

Moreover, the preliminary arrangement operations are a sort of manual operations relying on the memory of in-charge persons, thus leading to poor system developing and replacing properties. Also, collection parts data and supplier data are not unified with project (i.e., manager), thus giving rise to a problem of limitation on the lay-open of data with the project and useful way of use of the data.

By way of example, in case when parts collection is not only made solely in the own country but also in other countries, as the search with respect to a plurality of parts collection requests suppliers in the pertinent country district are searched in a simultaneously processing state. In this search, the parts collection categories cover versatile scopes, and for adequate supplier selecting operation the method of obtaining necessary data has to rely on introduction of suppliers from others, business field paper advertisement media or sales invitations. It is thus impossible to make adequate dealer selection between two countries. Also, new development of suppliers (i.e., delivering dealers) are pressed by other daily businesses and can not be sufficiently made.

Heretofore, as supplier data registered on the collection side only data obtained in the past are preserved as such, and data communication is performed by manual operation. In various field with pronounced technical development, it is thus quite difficult from the standpoint of cost to obtain data of excellent new suppliers and efficiently excavate promising suppliers.

Also, managers having companies or offices in our country are considerably spaced apart in distance from foreign country suppliers. Therefore, it takes time to obtain detailed specification data of parts required from the collection department by such means as facsimile, international mails and international home-delivery mails. Also, standard time difference may be present. Timely provision of purchase data of necessary parts to each supplier thus cannot be sufficiently made due to the above reasons and also to personal limitations. Presently, therefore, the development approach to new suppliers is not in good progress.

Furthermore, when sending detailed specification data by using electronic mails, after the mail reception the received data are sent to suppliers, with which past transactions were made. The research is thus inefficient, and it is difficult to grasp the parts collection status on the side of the site (i.e., foreign country) with respect to parts collection requesters in our country. It is further difficult to make independent approach from the supplier side to each in-charge person.

### SUMMARY OF THE INVENTION

An object of the present invention, therefore, is to provide a collection system with lay-open on web capable of laying open adequate collection subject data on web to suppliers, which are determined based on the importance and confidential level of the collection parts.

Another object of the present invention is to provide a collection system with lay-open on web capable of prescribing the scope of collection subject to be laid open based on the importance and confidential level of the collection subject.

A further object of the present invention is to provide a collection system with lay-open on web capable of application of not only new suppliers but also of registered suppliers while automatically managing and updating the supplier data.

A still further object of the present invention is to provide a collection system with lay-open on web capable of competition by a plurality of suppliers for cost reduction and also causing the collection side to make use of collection request items as separated technical materials.

According to an aspect of the present invention, there is provided a collection system with lay-open on web for laying open data of subject to be collected on web for determining, by a collection side, a supplier who has applied based on the subject data laid open on the web, wherein: the data to be laid open among the subject data is determined based on lay-open ranking corresponding to the confidential level of the subject, and the supplies to which the lay-open data are laid open is specified based on the lay-open ranking.

According to another aspect of the present invention, there is provided a collection system with lay-open on web for laying open data of subject to be collected on web for determining, by a collection side, a supplier who has applied based on the subject data laid open on the web, wherein: a collection side is ranked into a plurality of hierarchical layers; a rating for judging a confidential level of the subject is determined for each layer; a lay-open ranking is determined by taking the ratings determined for the plurality of layers into overall considerations; data to be laid open among the collection subject data is determined based on the lay-open ranking; and a supplier to which the lay-open data are laid open is specified based on the lay-open ranking.

According to other aspect of the present invention, there is provided a collection system with lay-open on web for laying open data of subject to be collected on web for determining, by a collection side, a supplier who has applied based on the subject data laid open on the web, wherein: on the collection side, registered suppliers are ranked into a plurality of supplier rank groups, and lay-open data among the collection subject data are determined and laid open based on the confidential level of the collection subject, the determined lay-open data being laid open to only the suppliers belonging to the rank group corresponding to the confidential level.

The collection side is ranked into a plurality of hierarchical layers, a rating competence as a weight is provided to each hierarchical layer, a rating provided to each supplier is determined by taking the rating competence (right) into considerations, and the supplier ranking of the registered suppliers is determined by taking the individual ratings determined for the plurality of hierarchical layers into considerations.

The collection side is ranked into a plurality of hierarchical layers, a rating competence as a weight is provided to each hierarchical layer, a rating provided to each collection subject is determined by taking the rating competences into considerations, and the laid-open ranking is determined by taking the individual ratings determined for the plurality of layers into overall considerations.

The plurality of hierarchical layers are sections with different responsibility competences, sections with greater responsibility competences being provided with greater rating competences.

According to still other aspect of the present invention, there is provided a collection system with lay-open on web for laying open data of subject to be collected on web for determining, by a collection side, a supplier who has applied based on the subject data laid open on the web, wherein: when the applied supplier is not a registered supplier but a new supplier on the collection side, data from the new supplier are registered, and when the applied supplier is a registered supplier, the registered data are updated.

According to further aspect of the present invention, there is provided a collection system with lay-open on web for laying open data of subject to be collected on web for determining, by a collection side, a supplier who has applied based on the subject data laid open on the web, wherein: the collection side determines as to whether the lay-open is to be made in open system or closed system based on the confidential level of the collection parts, while determining suppliers qualified to read lay-open data.

Lay-open data and suppliers qualified to read the lay-open data are determined by taking the importance of the collection parts as well into considerations. The lay-open date is limited. The lay-open data are transmitted by electronic mails to the specified suppliers qualified to read the data. The subject to be collected is parts, articles or services.

Other objects and features will be clarified from the following description with reference to attached drawings.

### BRIEF DESCRIPTION OF THE DRAWINGS

FIG. 1 shows a system construction of a collection system with lay-open on web according to an embodiment of the present invention;

FIG. 2 shows a system construction and a routine for the determination of the “lay-open level ranking” in the embodiment;

FIG. 3 shows a collection parts specification format in the embodiment;

FIG. 4 shows a pertinent detail file in the embodiment;

FIG. 5 shows a collection request list in the embodiment;

FIG. 6 shows a limited requirements list in the embodiment;

FIG. 7 shows a spec. summary in the embodiment;

FIG. 8 shows a lay-open web page in the embodiment; and

FIG. 9 shows a supplier registration application format in the embodiment.

### PREFERRED EMBODIMENTS OF THE INVENTION

Preferred embodiments of the present invention will now be described with reference to the drawings.

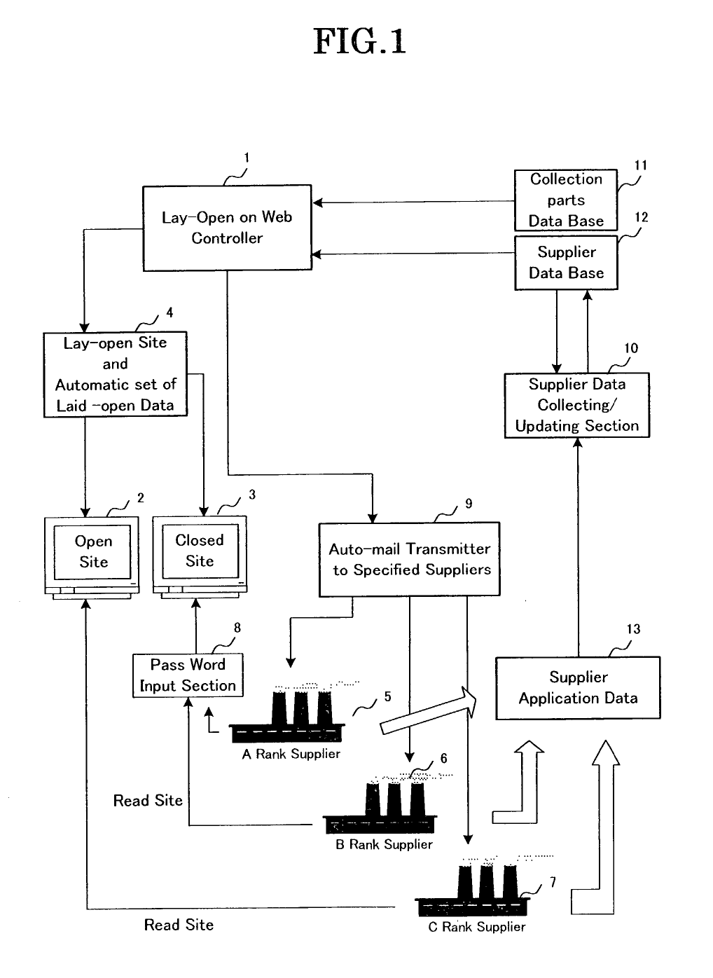

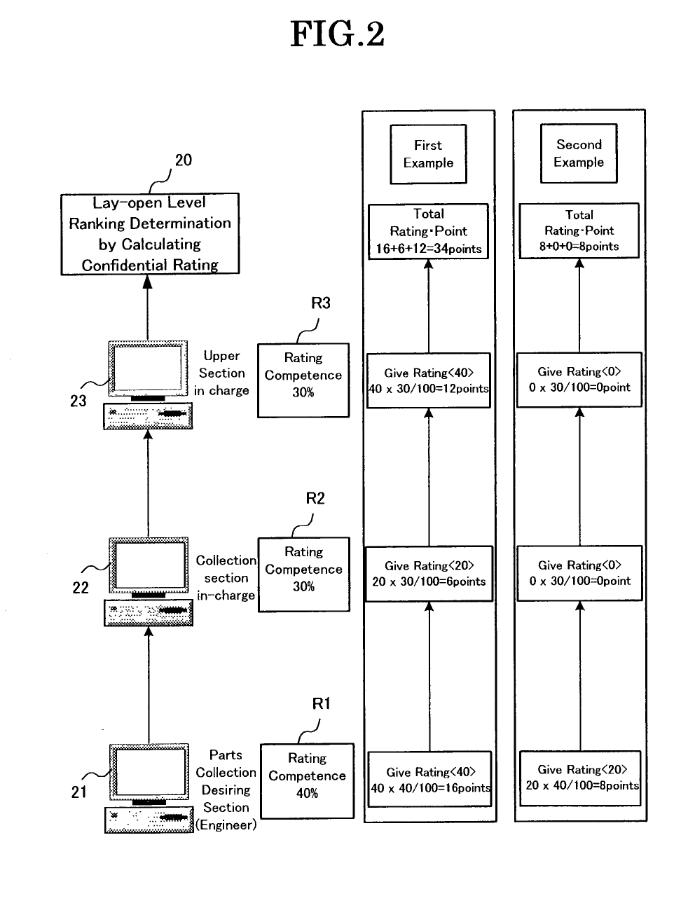

This embodiment of the collection system will now be described with reference to FIGS. 1 and 2. According to the present invention, the subject of collection is not limited to parts and like hardware materials, but any matter such as services is covered. This embodiment will be described in connection with parts as the subject of collection.

In this embodiment, for managing the collection, collection data for laying open on web and suppliers, to which the collection data are to be laid open, are determined based on “lay-open level ranking”, which is provided as confidential level given to collection parts by taking the importance and confidential nature into considerations, and also to “supplier ranking”, which is given on the collection side to suppliers as registered suppliers on the basis of reliability, technical power and other factors. A further determination is made as to whether the lay-open on web is to be made on open site or closed site, which is not lay-open site. When laying data open on the closed site, a determination is made as to whether collection parts data are to be provided to only registered particular suppliers by electronic mails or the like.

The “lay-open level ranking” is determined by classifying the collection side department or section into a plurality of hierarchical layers and by taking ratings, which are determined for the individual layers on the basis of the importance and confidential nature, into overall considerations. The “supplier ranking” also can be determined by taking ratings, which are determined for the individual layers on the basis of the reliability, technical power and so forth, into overall considerations.

The data to be laid open are determined according to the “lay-open level ranking”, and also suppliers for laying data open thereto are also specified. Data are laid open to only suppliers, which belong to a “supplier ranking” corresponding to the confidential level of the collection parts. When a supplier having made an application is not found on the collection side to be a new supplier other than registered supplier, data from this new supplier are registered. In the case of a registered supplier, the registered data are updated.

Referring to FIG. 1, a lay-open controller 1 determines laying data open on either an open site 2 or a closed site 3 based on collection parts data containing “lay-open level ranking” stored in a collection parts database 11, and also determines the lay-open range of collection parts data to be laid open on web based on the “lay-open level ranking”.

As noted above, on the collection site “supplier ranking” of registered suppliers qualified to apply for parts collection is predetermined on the basis of such factors as trust, technical power, past collection results, company scale and past transaction status. For example, the registered suppliers are ranked into a plurality of groups, such as rank A to C suppliers 5 to 7.

The rank C suppliers 7 are the lowest rank suppliers without any collection result, for instance, and can read only lowest confidential level collection data laid open on the open site 2. That is, the suppliers of this rank can read only low “lay-open level ranking” contents of the lowest confidential level among collection parts lay-open data produced on the collection side.

The rank B suppliers 6 are medium rank suppliers having relatively considerable collection result, for instance. That is, the suppliers of this rank can read collection data of medium confidential level as the contents laid on the web at the closed site 3.

The rank A supplies 5 are the highest rank suppliers having highest trust and technical power and also having sufficient collection results, for instance. The suppliers of this rank can read collection data of the highest confidential level as the contents laid open on the web at the closed site 3.

To the lay-open controller 1 are inputted collection parts data (including “lay-open level ranking”) from the collection parts database 11 and supplier data (including “supplier ranking”). According to these inputted data, such processes as determination of the kind (either open or closed) of the web site on which collection part data are laid open, determination of the scope of the laid-open collection parts data and determination of a supplier are to be laid open, are executed. According to the determination by the lay-open controller 1, either the open or the closed site 2 or 3 is driven, and also an auto-mail transmitter 9 is driven to inform to determined supplier, to which the collection parts data are to be laid open, that the collection parts data are laid open on the web of the closed site 3 or to transmit automatically prescribed collection parts data.

All the suppliers can access collection parts data laid open on the web on the open site 2, and a supplier having read the data on the site can apply for parts collection by transmitting application data to the collection side. The transmitted data is received in a supplier data collecting/updating section 10. In the case of application by a new supplier, the data is stored as new supplier data in a supplier database 12. In the case of application by a registered supplier, data stored in the supplier database 12 are updated so that always newest data are stored.

In the case of laying data open on the web on the closed site 3, suppliers qualified to access the site (i.e., rank A and B supplies 5 and 6 in this embodiment) input individual passwords in a password input section 8, and then read out the contents on the web to make determination as to whether an application is to be made. The application data from the suppliers 5 and 6 are also received in the supplier data collecting/updating section 10, and data in the supplier database 12 are updated so that always newest data are stored. When automatically prescribed collection parts data are transmitted from the auto-mail transmitter 9, determination as to whether application is to be made is performed based on the received collection parts data. When it is determined to make application, application data is transmitted in the above way.

The determination of the “lay-open level ranking” is executed in a process shown in FIG. 2, for instance. Referring to the Figure, to a first level in-charge section 21 as a parts collection desiring section (i.e., engineer as an in-charge person), a second level in-charge section 22 as a hierarchically upper in-charge section (i.e., manager) or the like and a third level in-charge section 23 as a further hierarchically upper person in charge of collection are allotted rating competences R1 to R3, respectively, as weights. For example, 40%, 30% and 30% are allotted as the rating competences R1 to R3 to the first to third level in-charge sections 21 to 23, respectively.

The rating competences R1 to R3 are allotted independently for each of the first to third in-charge sections 21 to 23, and are preset based on the technical confidential property and importance of the collection parts. A point value which is obtained by multiplying the value of the “rating point” by the percent value of the above rating competence represents the confidential level.

The “rating point” is determined by the judgment based on the technical confidential level and the importance. The judgment is performed based on whether the collection parts used for the product which has already been manufactured and on sale or the collection parts are used for a new product to be sold. The way of providing the point is determined on such basis as whether the technical content of the parts is constituted by the sole existing techniques or includes new techniques and key technology. For example, the value of the rating point is determined on the basis of the technical confidential property, and is preset to, for instance, “0”, “20” and “40” in low, medium and high confidential level cases, respectively.

Byway of specific example, in the case of the first example shown in FIG. 2, with the rating point judged to be “40” in the first level in-charge section 21, a value obtained by multiplying this value of “40” by the own “rating competence” value of 40%, i.e., 40×(40/100)=16, is the rating point provided by the first level in-charge section 21.

With the rating point judged to be “20” in the second level in-charge section 22, a value obtained by multiplying this value of 20 by the own “rating competence” value of 30%, i.e., 20×(30/100)=6, is the rating point provided by the second level in-charge section.

With the rating point judged to be “40” in the third level in-charge section 23, a value obtained by multiplying this value of “40” by the own “rating competence” of 30%, i.e., 40×(30/100)=12, is the rating point provided by the third level in-charge section 23.

The three different rating points obtained in this way are added together, and the sum (16+6+12=34), i.e., the total rating point, serves as data and used as reference data specifying lay-open content (i.e., scope) in the collection parts lay-open and the qualified supplier (or suppliers). In this case, the total rating point 34 is judged to correspond to relatively important and highly confidential collection parts data. Thus, the qualified suppliers for reading the laid-open contents are limited to the registered suppliers, that is, the collection parts data contents are laid open on the closed site web (see FIG. 1) only for these registered suppliers. The collection parts data can be laid open in such manner as to limit the entry in the pertinent site or to distribute auto-mails to electronic mail addresses of the pertinent registered suppliers.

In the case of the second example, like the first example, the rating point is judged to be “20”, “0” and “0” in the first to third level in-charge sections 21 to 23. Values which are obtained by multiplying these rating points by the respective “rating competence” percent values are rating points of the “lay-open level ranking” in the individual sections, and the sum of these points, i.e., (8+0+0=8), the total “lay-open level ranking”, i.e., the total rating point. In the instant case, the total rating point of “8” is judged to low importance (confidential level) collection parts data. Thus, the qualified suppliers are not limited to the registered suppliers, and the collection parts data are laid open on the open site web to all the suppliers including the new suppliers.

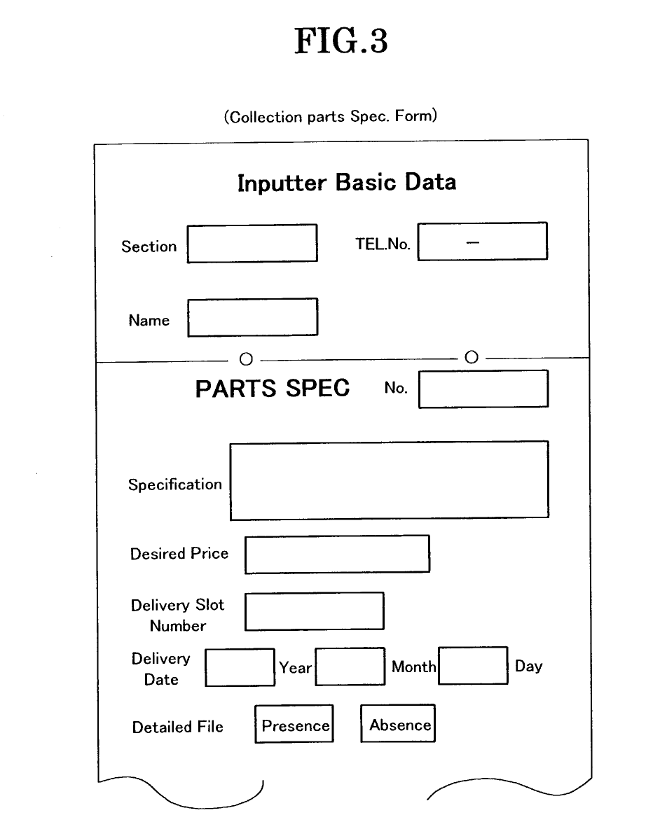

Desired collection parts data are inputted from the first to third level in-charge sections 21 to 23 to an input interface by using a collection parts specification format as shown in FIG. 3, for instance. In this format, section, telephone number and name are entered in an “INPUTTER'S BASIC DATA” item, and collection No., specification, desired price, delivery slot number, delivery date and presence/absence of detailed file are entered in a “PARTS SPEC.” item. Then, by clicking a transmission button, the written data are stored in the collection part database 11.

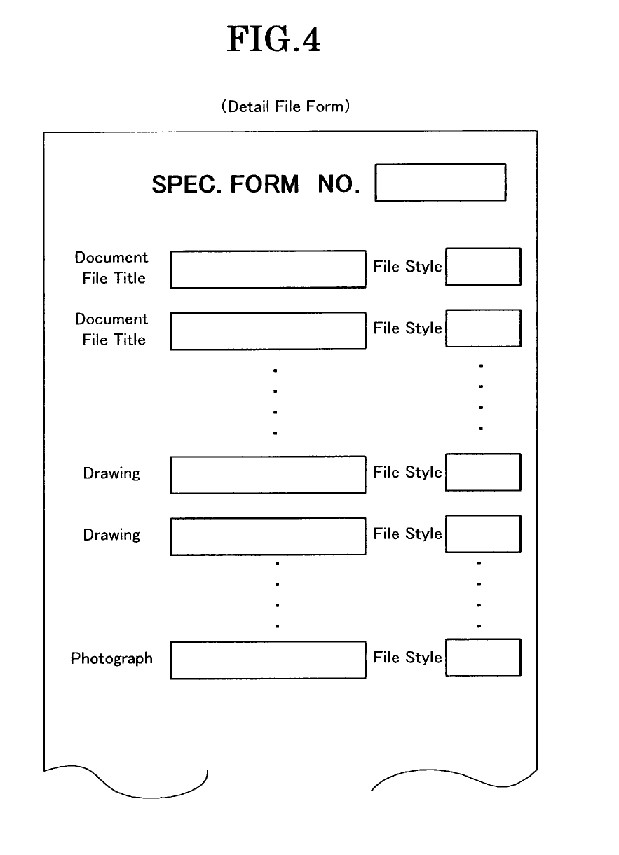

When detail file form is present at the time of collection parts manufacture with collection parts spec. form, it is necessary to set the contents of the pertinent detail file in details by opening an annexed file contents form as shown in FIG. 4. At this time, spec. form No. is first entered in the annexed file contents form, then document file titles and corresponding file styles are entered. Then, when a drawing is present, the drawing title and file style are entered. When a photograph is present, the photograph title and file style are entered. Thereafter, a transmission button is clicked. As a result, detail data of the annexed file contents are stored as collection parts data in the database 11.

The suppliers 5 to 7 as a plurality of suppliers ranked into the three rank groups A to C, can read only contents corresponding to the “lay-open level ranking”. With a “lay-open level ranking” point number is 0 to 20, the contents are laid open not for the sole rank C suppliers but for all the suppliers. With a point number of 21 to 30, the contents are laid open not only for the rank B suppliers but also for the rankA suppliers 5. With a point number of 31 to 40, the contents are laid open to the sole rank A supplies 5.

Parts collection sections of projects desiring parts collection (i.e., first to third level in-charge sections 21 to 23 as shown in FIG. 1) withdraw the parts collection request from each section as collection parts data to a web database of the lay-open controller 1. When it is judged, on the basis of the “lay-open level ranking”, that it is possible to lay open the details of parts desired to be collected to the outside of the company, the details are laid open as desired collection parts on the open site on lay-open server. The managing side can accept parts supply applications from suppliers irrespective of whether the suppliers are registered or non-registered new supplier.

To the registered suppliers registered by a managing side, new desired collection parts are laid open on the open site 2, and at the same time desired collection parts details are automatically transmitted by electronic mails from the auto-mail transmitting section. The registered suppliers, like new suppliers, can be stimulated to apply to parts collection. Thus, the parts collection can be broadly carried out in a multiple and energy-saving manner. Consequently, it is possible to reduce the cost and delivery term of collection parts.

As for collection parts data produced by either of the first to third level in-charge sections 21 to 23, desired collection parts data input interface using web page is prepared. Thus, details of parts, annexed documents, drawings, photographs, etc. can be up-loaded as collection parts data without use of any special software, and the up-loaded data are stored in database.

While the data stored in the database can be made common to various sections in the company by web page managed in, for instance, the password input section 8, they are sorted out in a “lay-open “OK”/“NO” evaluating system” to be described later. When a lay-out “OK” decision is made, the contents are automatically laid open on the open site 2. At the same time, the same contents are automatically transmitted to electronic mail addresses stored in the electronic mail database in the auto-mail transmitting section 9.

The photographs, detailed contents, etc. of parts laid on the open site 2 can be read by anybody. When a supplier having read the contents is to apply to the parts collection, it can transmit supplier data including details of the own company and the manufacturing plant as supplier application data from an “Application Format” provided in the web page of the pertinent open site 2 to the collection side.

The supplier application data are transmitted as electronic mail addressed to a preset managing section, and are also stored in the supplier database in the auto-mail transmitting step section 9. These data can be made common to the first to third in-charge sections 21 to 23. In this case, the contents of data that can be laid open are limited according to the confidential level of each in-charge section.

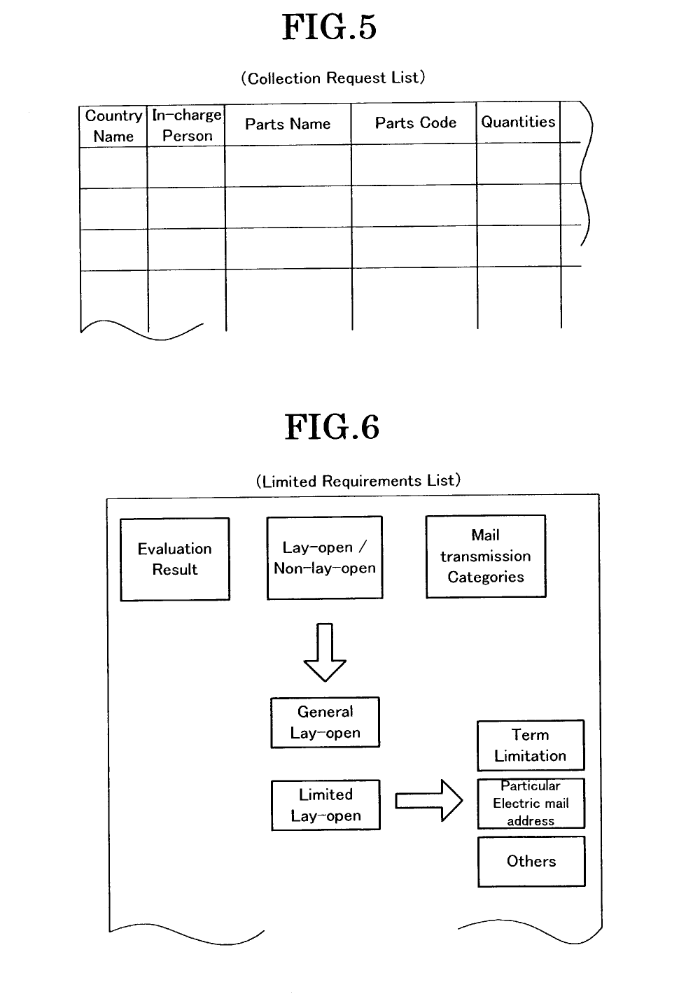

The data thus stored as collection parts data in the database, can be simply taken out as a list of a plurality of parts collection request data from the pertinent database. For example, as in collection request list shown in FIG. 5, it is possible to taken out the country names, in-charge persons, parts names, parts codes, prices, quantities, etc. together with data about the presence/absence of annexed material. The list may contain a check mark specifying either the open site 2 or the closed site 3, on which to laid open the contents.

As for the determination as to whether or not the contents are to be laid open on the open site 2, the final point calculation is made on the basis of each of the ratings inputted in the order of the first to third in-charge sections 21 to 23 and also of references predetermined by a server program. When and only when certain requirements are met, the contents are laid open on the open site 2. Otherwise, the contents are laid open on the closed site 3.

The above requirements are displayed as a requirements list as shown in FIG. 6. What are displayed are the final “evaluation result”, “lay-open/non-lay-open”, and whether the lay-open is “general lay-open” or “limited lay-open”. When a requirement is provided to the “general lay-open”, designations as to whether the requirement content is a “term limitation”, i.e., a confidential term until the technical contents can be laid open, whether a limitation of the lay-open districts (or countries) is to be provided and whether the lay-open term is to be set in dependence on the districts, are made.

It is also possible to confirm by reading such restriction data as “particular electronic mail address” and “others” when defining a service window in a “particular electronic mail address”.

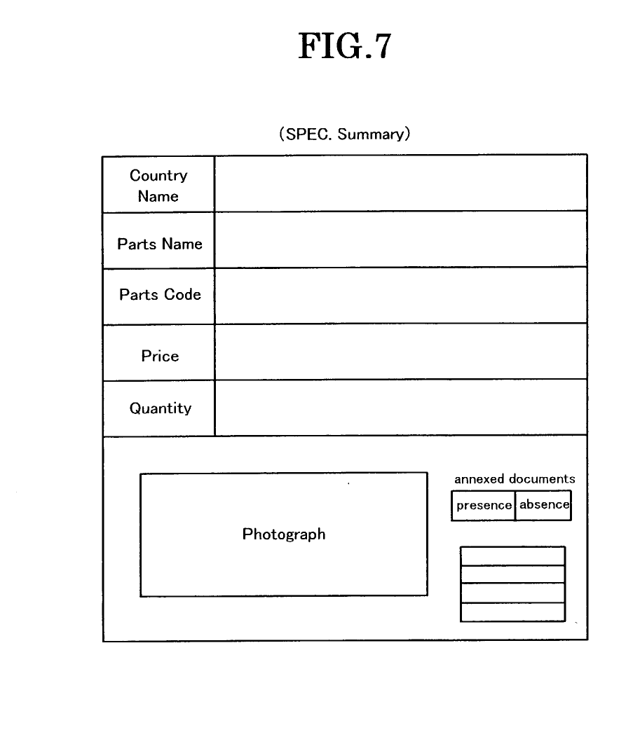

The collection parts data laid open as collection parts lay-open data, are displayed as, for instance, “spec. summary” as shown in FIG. 7. As shown, the “country name”, “parts name”, “part code”, “price” and “quantity” are displayed. When a photograph is attached to the pertinent part, the photograph is displayed. Furthermore, presence/absence of annexed document and a list of documents, if any, are displayed.

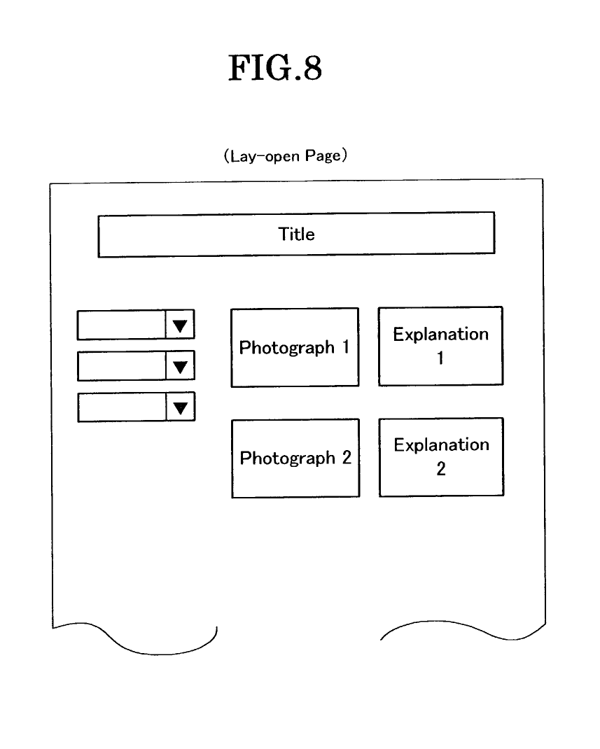

On the lay-open page displayed on the open site 2 or the closed site 3, as in “lay-open web page”, shown in FIG. 8. This page is preset as follows. “TITLE” of the desired collection parts is displayed at the top. Under the “TITLE”, photograph 1 and explanation 1 of first member are displayed. Further underneath, photograph 2 and explanation 2 of a second part are displayed. In this way, photographs and explanations of a plurality of parts are displayed. If necessary, it is possible to select an adequate choice branch such as parts category on the left side of the photograph display parts.

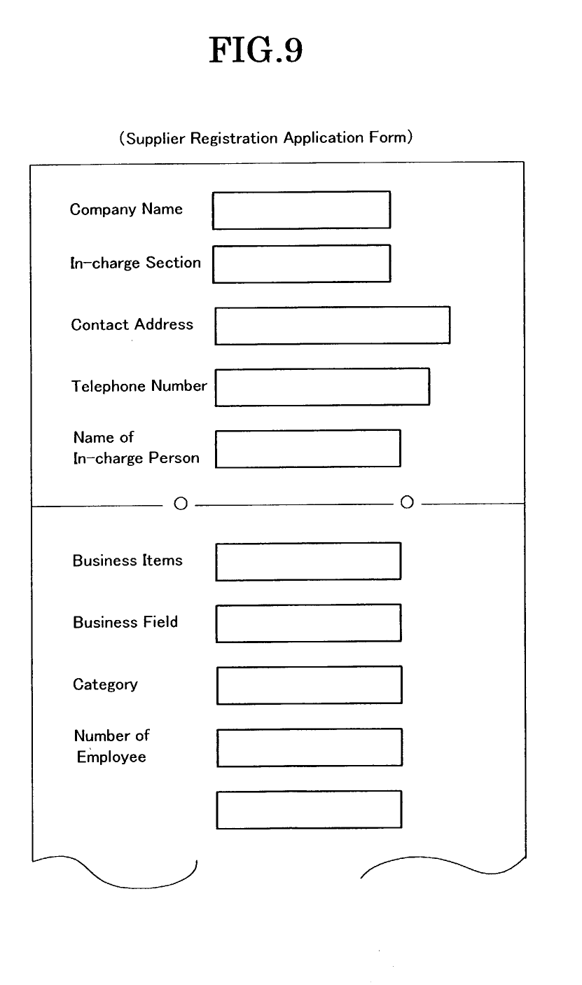

Registration data of a plurality of suppliers are stored in the database contained in the supplier application data as shown in FIG. 1. When a new supplier applies for parts collection, supplier registration is persuaded. For example, by inputting data in a “supplier registration application format” as shown in, for FIG. 9, the new supplier now can start collection dealing for succeeding collection as registered supplier. It is thus possible to build a new database. To the supplier registration application format, such basic items of the new supplier as company name, in-charge section, contact address, telephone number and name of in-charge person and also such business items of the new supplier as scale, items dealt with, business field and dealt-with item category are inputted. By so doing, the pertinent contents are stored in the data base of the lay-open controller 1.

In the above embodiment, a plurality of parts collection request data classed hierarchically by the three levels of first to third in-charge sections 21 to 23 and the rating, and the number of hierarchical layer can be freely chosen.

The confidential level is such a designation as to set the presence/absence of lay-open/non-lay-open, to set the lay-open date or to set limitation on lay-open districts (countries) or lay-open term. However, it is also possible to set the lay-open term independently for each country or for each district. The collection part data lay-open step may use an internet communication line or a communication line using exclusive line.

It is further possible that the designation of collection parts data which is made by the web lay-open controller 1 includes an electronic mail designation of collection parts data to particular suppliers determined on the basis of the collection level and confidential level, that the collection parts data can be simultaneously read by a plurality of suppliers in correspondence to the confidential data and the collection level, and that the designation includes an auction step, in which a pertinent supplier can lay open a managing side answer for simultaneous study thereof by a plurality of suppliers.

As has been described in the foregoing, with the parts collection system based on lay-open on web according to the present invention, it is possible to efficiently find new suppliers even with release of collection parts data to the indefinite multitude, substantially eliminate manual-like pre-arrangement business with suppliers and permit system management without substantially dependence on the experience and intuition of persons in charge of the collection but with an objective point providing system, thus permitting efficient system management. In addition, collection data and supplier data are unified inside the project (or manager) to provide for database, and it is thus possible to lay data open inside the project and make effective use of the laid-open data.

Thus, according to the present invention it is possible to lay adequate collection data open on web to suppliers, which are determined in dependence on the importance and confidential nature of the collection parts and prescribe the scope of lay-open of collection parts in dependence on the importance and confidential nature of the collection parts. Also, it is possible to permit application by not only new suppliers but also registered suppliers and automatic management and updating of such supplier data. Furthermore, it is possible to obtain pronounced effects that price reduction is obtainable with competition of a plurality of suppliers and also that collection request items can be utilized as separate technical material on the collection side.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A collection system with lay-open on web for laying open data of subject to be collected on web for determining, by a collection side, a supplier who has applied based on the subject data laid open on the web, wherein:
the data to be laid open among the subject data is determined based on lay-open ranking corresponding to the confidential level of the subject, and the supplies to which the lay-open data are laid open is specified based on the lay-open ranking.

2. A collection system with lay-open on web for laying open data of subject to be collected on web for determining, by a collection side, a supplier who has applied based on the subject data laid open on the web, wherein:
a collection side is ranked into a plurality of hierarchical layers;
a rating for judging a confidential level of the subject is determined for each layer;
a lay-open ranking is determined by taking the ratings determined for the plurality of layers into overall considerations;
data to be laid open among the collection subject data is determined based on the lay-open ranking; and
a supplier to which the lay-open data are laid open is specified based on the lay-open ranking.

3. A collection system with lay-open on web for laying open data of subject to be collected on web for determining, by a collection side, a supplier who has applied based on the subject data laid open on the web, wherein:
on the collection side, registered suppliers are ranked into a plurality of supplier rank groups, and lay-open data among the collection subject data are determined and laid open based on the confidential level of the collection subject, the determined lay-open data being laid open to only the suppliers belonging to the rank group corresponding to the confidential level.

4. The collection system according to claim 3, wherein the collection side is ranked into a plurality of hierarchical layers, a rating competence as a weight is provided to each hierarchical layer, a rating provided to each supplier is determined by taking the rating competence (right) into considerations, and the supplier ranking of the registered suppliers is determined by taking the individual ratings determined for the plurality of hierarchical layers into considerations.

5. The collection system according to claim 1 or 2, wherein the collection side is ranked into a plurality of hierarchical layers, a rating competence as a weight is provided to each hierarchical layer, a rating provided to each collection subject is determined by taking the rating competences into considerations, and the laid-open ranking is determined by taking the individual ratings determined for the plurality of layers into overall considerations.

6. The collection system according to claim 2, 4 or 5, wherein the plurality of hierarchical layers are sections with different responsibility competences, sections with greater responsibility competences being provided with greater rating competences.

7. A collection system with lay-open on web for laying open data of subject to be collected on web for determining, by a collection side, a supplier who has applied based on the subject data laid open on the web, wherein: when the applied supplier is not a registered supplier but a new supplier on the collection side, data from the new supplier are registered, and when the applied supplier is a registered supplier, the registered data are updated.

8. A collection system with lay-open on web for laying open data of subject to be collected on web for determining, by a collection side, a supplier who has applied based on the subject data laid open on the web, wherein:
the collection side determines as to whether the lay-open is to be made in open system or closed system based on the confidential level of the collection parts, while determining suppliers qualified to read lay-open data.

9. The collection system according to one of claims 1 to 8, wherein lay-open data and suppliers qualified to read the lay-open data are determined by taking the importance of the collection parts as well into considerations.

10. The collection system according to one of claims 1 to 9, wherein the lay-open date is limited.

11. The collection system according to one of claims 1 to 10, wherein the lay-open data are transmitted by electronic mails to the specified suppliers qualified to read the data.

12. The collection system according to one of claims 1 to 11, wherein the subject to be collected is parts, articles or services.
